(19) United States
(12) Patent Application Publication
(10) Pub. No.: US 2008/0055394 A1
(43) Pub. Date: Mar. 6, 2008

(54) VIDEO PHONE DEVICE

(75) Inventor: Gwo-Hwa Shiue, Taipei City (TW)

Correspondence Address: WORKMAN NYDEGGER, 60 EAST SOUTH TEMPLE, 1000 EAGLE GATE TOWER, SALT LAKE CITY, UT, 84111, US

(73) Assignee: INVENTEC MULTIMEDIA & TELECOM CORPORATION, Taipei City (TW)

(21) Appl. No.: 11/465,404

(22) Filed: Aug. 17, 2006

(51) Int. Cl. H04N 7/14

(52) U.S. Cl. 348/14.01

(57) ABSTRACT

A video phone device is provided, which comprises a phone set, a first screen device, a first video camera device, and a second screen device, wherein the phone set is used for establishing video and audio communications with a communication partner over a network; the first screen device is installed on the phone set for displaying a video image from the partner; the first video camera device is installed on the first screen device for capturing image information; and the second screen device is connected to the phone set in a wired or wireless communication way for displaying the video image of the communication partner. Therefore, the scope and content of the image display are enlarged and the number of users and application range of the video phone are increased.

### BACKGROUND OF THE INVENTION

1. Field of Invention

The present invention relates to a phone device, and more particularly to a phone device with the function of displaying images.

2. Related Art

Currently, through equipping an imaging device on a communication terminal, a phone device for capturing an image and making a video call appears, that is, a video phone. The video phone is characterized in shooting and imaging the pictures of calling and called parties through an image capturing device installed therein, and then displaying the images on a built-in screen, such that both parties can see each other while talking.

However, as the video phone has been widely used, a demanding for mobility or an extension phone also appears. Particularly when many people use the video phone at the same time, for example, during a video conference or a multi-party call, the scope of the image display is limited due to the limited screen of the video phone, thereby causing an inconvenience for making a call.

### SUMMARY OF THE INVENTION

It is an object of the present invention to provide a video phone device for solving the problem of the limited scope of the image display and increasing the mobility of video phone device.

The video phone device provided by the present invention includes a phone set, a first screen device, a first video camera device, and a second screen device. The phone set is used for establishing video and audio communications with a communication partner over a network, the first screen device is installed on the phone set for displaying a video image from the partner, the first video camera device is installed on the first screen device for capturing the image information, and the second screen device is connected to the phone set in a wired or wireless communication way for displaying the video image of the partner.

According to the video phone device of the present invention, as for the wired communication, the transmission medium for the video image may include a network cable, USB transmission line, coaxial cable, and audio-video transmission line. In addition, as for the wireless communication, the transmission medium for the image signal may include WiMax, WiFi, and blue-tooth technology.

According to the video phone device of the present invention, the first screen device is removable. The phone set has a guide rail and a plurality of pillars. The first screen device has a guide slot and a plurality of guide holes. The number and dimension of the guide slot and guide holes are corresponding to that of the guide rail and pillars, and the guide rail and the guide slot are matched with each other, and the pillars and the guide holes are also matched, such that the first screen device is combined and positioned on the phone set. The matching between the pillars and the guide holes is further fixed under a magnetic force. The first screen device and the second screen device may be alternated with each other.

According to the video phone device of the present invention, a second video camera device is further installed on the second screen device for capturing the image information and then transmitting the image information to the phone set in a wired or wireless communication way.

According to the video phone device of the present invention, a stand is installed within the second screen device and connected to the second screen device via a spindle mechanism to support the second screen device.

According to the video phone device of the present invention, the second screen device has a base for fixing the second screen device, wherein the base is preferably a platform-shaped base or a wall-hung base.

Through being equipped with an extended second screen device, the video phone device of the present invention enlarges the scope and content of the image display, and also meets the multi-point and mobility requirements within a video phone area. When the video phone is used by many people at the same time, with the extended screen device, it is more convenient to browse an image.

Additionally, the screen device of the phone set for the video phone of the present invention is designed to be removable, and to be alternated with the extended second screen device, thus, the screen device of the phone set achieves the maximum service efficiency and also achieves the anticipated object of being removable.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus is not limitative of the present invention, and wherein:

FIG. 1 is a schematic view of a video phone device according to the present invention;

FIGS. 2a to 2d are schematic views of a second screen device and the fixing method according to a first embodiment of the present invention;

FIGS. 3a to 3d are schematic views of a second screen device and the fixing method according to a second embodiment of the present invention;

FIGS. 4a to 4c are schematic views of a second screen device and the fixing method according to a third embodiment of the present invention; and

FIGS. 5a to 5c are schematic views of the video phone device according to another embodiment of the present invention.

### DETAILED DESCRIPTION OF THE INVENTION

The preferred embodiments of the present invention will be illustrated below in detail with reference to the accompanying drawings.

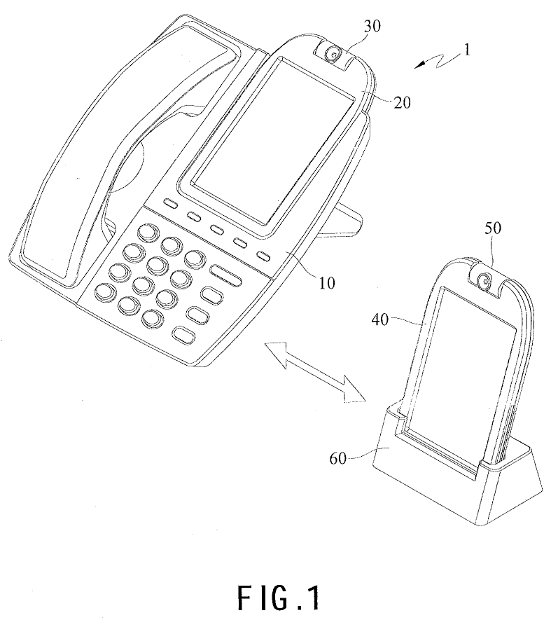

As shown in FIG. 1, it is a schematic view of a video phone device according to the present invention. In FIG. 1, the video phone device comprises a video phone 1 and a screen device, i.e., a second screen device 40. The video phone 1 includes a phone set 10, a first screen device 20, and a first video camera device 30, wherein the phone set 10 is used for establishing video and audio communications with a communication partner over a network; the first screen device 20 is installed on the phone set 10 for displaying a video image from the communication partner; the first video camera device 30 is installed on the first screen device 20 for capturing image information within the current range. Naturally, the video phone 1 further comprises other essential devices conventionally used for transmitting audio and video in communications, which will not be described herein any more.

The second screen device 40 is connected to the phone set 10 in a wired or wireless communication way, such that the video image of the first screen device 20 is transmitted to the second screen device 40, and then the received video image of the communication partner is displayed. The wired communication way may include a network cable, a USB transmission line, a coaxial cable, an audio-video transmission line, and the like, thus, a video image is transmitted between the video phone 1 and the second screen device 40 via the corresponding transmission interface (not shown) disposed on the phone set 10 and the second screen device 40. The video image may be further transmitted between the video phone 1 and the second screen device 40 via the wireless communication way with WiMax, WiFi, or blue-tooth technology as the transmission medium. Although only one second screen device 40 is provided in FIG. 1, it should be noted that the video phone device of the present invention is not limited to having one second screen device, and the second screen device herein is defined from a general point of view, so any screen device used for screen extension of the video phone in the above way can be called the second screen device of the present invention, that is, the present invention may comprise at least one extended screen device.

Through extending one or more screen devices in the conventional video phone, the present invention not only enlarges the display scope and content, but also increases the number of users and application range of the video phone, and due to having a second screen, it is more convenient for browsing when many people use the video phone at the same time, for example, during a video conference or a three-party talk.

As shown in FIG. 1, a second video camera device 50 is further installed on the second screen device 40 for capturing the image information within a certain range and then transmitting the image information to the phone set 10 through the above-mentioned wired or wireless communication way, such that a bidirectional data transmission between the phone set 10 and the second screen device 40 is achieved. Naturally, this image information may be further transmitted to the communication partner by the phone set 10, thereby displaying multi-party video images. Therefore, the second video camera device 50 is useful for enlarging the image monitoring scope.

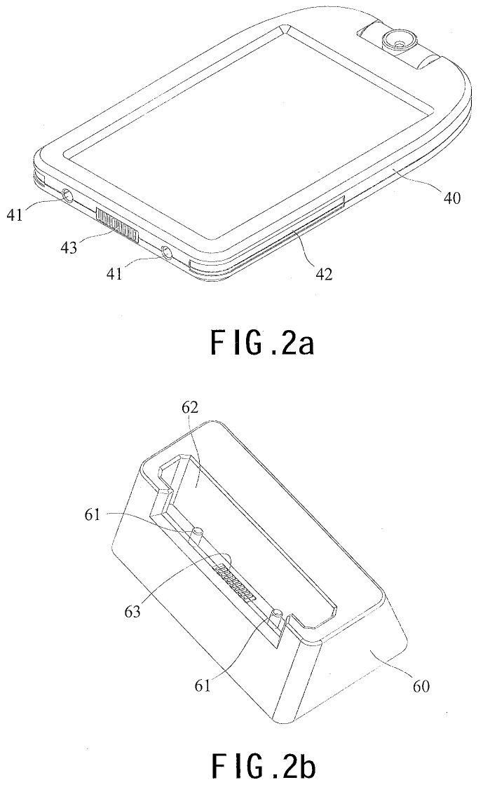

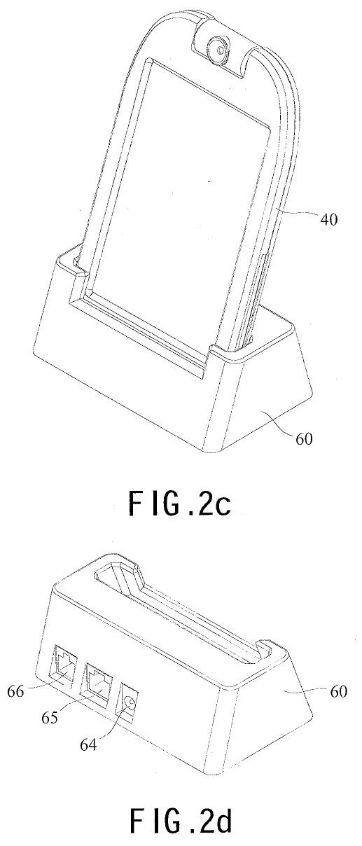

Additionally, in FIG. 1, the second screen device 40 may further have a base 60 for supporting and fixing the second screen device 40. The base 60 and the structure of the correspondingly disposed second screen device 40 are illustrated below in detail with reference to FIGS. 2a to 2d, and they are schematic views of a second screen device and the fixing method according to a first embodiment of the present invention.

As shown in FIG. 2a, guide holes 41, a guide slot 42, and a plurality of pins 43 are disposed at the bottom of the second screen device 40. In FIG. 2b, a base 60 is provided for placing and fixing the second screen device 40, which is platform-shaped and correspondingly has pillars 61, a guide rail 62, and pins 63. The guide holes 41 and the pillars 61, the guide slot 42 and the guide rail 62, the pins 43 and the pins 63 are correspondingly matched with each other, such that the second screen device 40 and the base 60 are combined and positioned, and the pins 43 in the second screen device 40 and the pin 63 in the base 60 are ensured to be matched accurately. In addition, the guide holes 41 and the pillars 61 may be made of magnetic materials, such that both of them are more accurately positioned under the magnetic force therebetween.

FIG. 2c is a schematic view of the assembly of the second screen device 40 and the base 60 with the above structure. As shown in FIG. 2d, a power jack 64, a cable jack 65, a phone jack 66, and the like may be installed on the back of the base 60, and signals are transmitted through the cable jack 65 in a wired communication way. The cable jack 65 may be various jacks for receiving a network cable, a USB transmission line, a coaxial cable, or an audio-video transmission line used in the wired communication, and thereby the image information is transmitted between the phone set 10 and the second screen device 40.

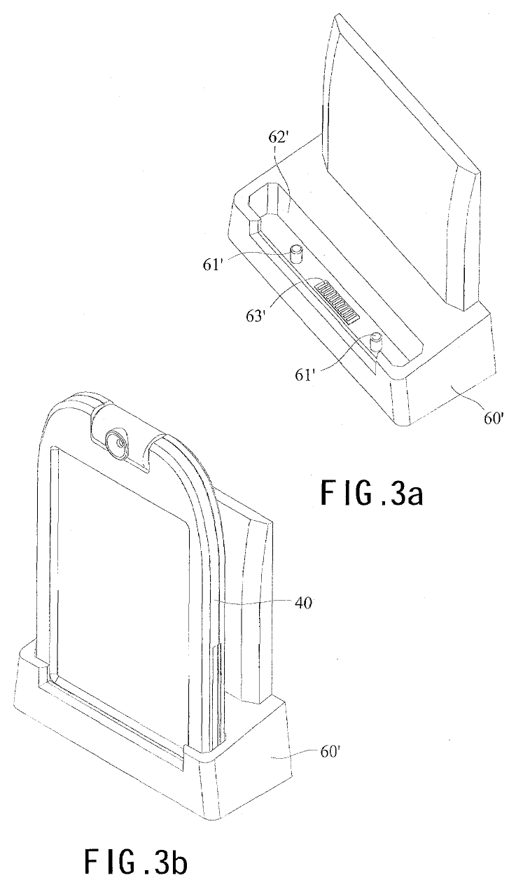

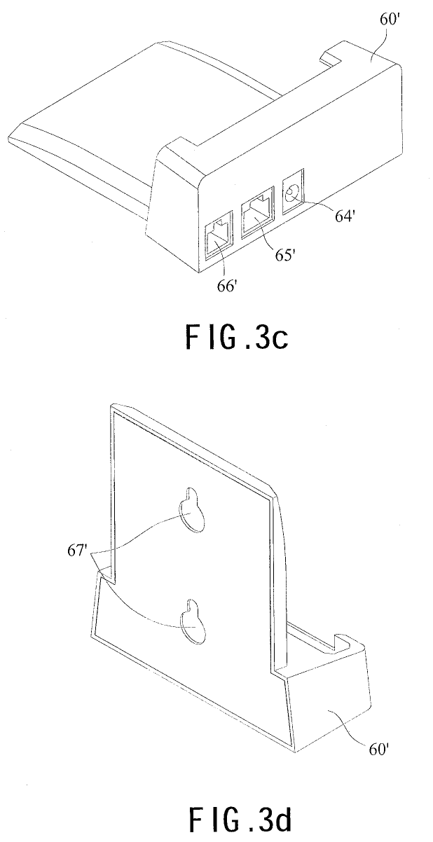

As shown in FIGS. 3a to 3d, they are schematic views of a second screen device and the fixing method according to a second embodiment of the present invention. In the embodiment shown in the figures, the structure of the second screen device is similar to that of FIG. 2a, that is, the second screen device 40 is also fixed with a base, but only differs in the base structure used for fixing the second screen device 40, which will be illustrated below in detail with reference to FIGS. 3a to 3d.

FIG. 3a is a schematic view of a base in this embodiment. The base 60′ is a wall-hung base and has pillars 61′ and a guide rail 62′ with structures being the same as or similar to that of the pillars 61 and the guide rail 62 of the base 60, which thus will not be described herein repeatedly. Therefore, a schematic view of the assembly of the base 60′ and the second screen device 40 after they are combined is shown in FIG. 3b. In addition, as shown in FIG. 3c, a power jack 64′, a cable jack 65′, a phone jack 66′, and the like may be disposed at the bottom of the base 60′, the structures of which are the same as or similar to that of the interfaces of the base 60, which thus will not be described herein repeatedly. A plurality of fixing holes 67′ is installed on the back of the base 60′ to fix the base 60′ and the second screen device 40 mounted thereon by hanging them on the wall.

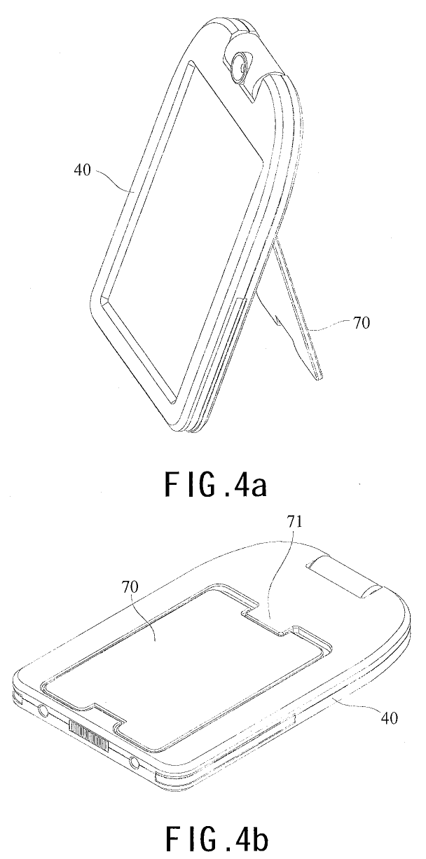

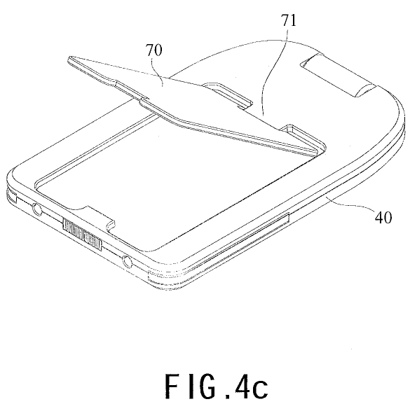

FIGS. 4a to 4c are schematic views of a second screen device and the fixing method according to a third embodiment of the present invention. In this embodiment, a stand 70 is disposed on the second screen device 40 as a base, such that the second screen device 40 is supported and fixed at an appropriate position, that is, it may stand separately, as shown in FIG. 4a, which is a schematic view in the case that the second screen device 40 is fixed by the stand 70. The stand 70 is preferably connected to the second screen device 40 through a spindle mechanism 71, such that the stand 70 can be opened or folded around the spindle mechanism 71. Furthermore, the stand 70 is preferably of a hidden type, that is, it is disposed within the body of the second screen device 40. FIG. 4b is a schematic view of the stand 70 in an opened state, and FIG. 4c is a schematic view of the hidden-type stand 70 folded within the second screen device 40.

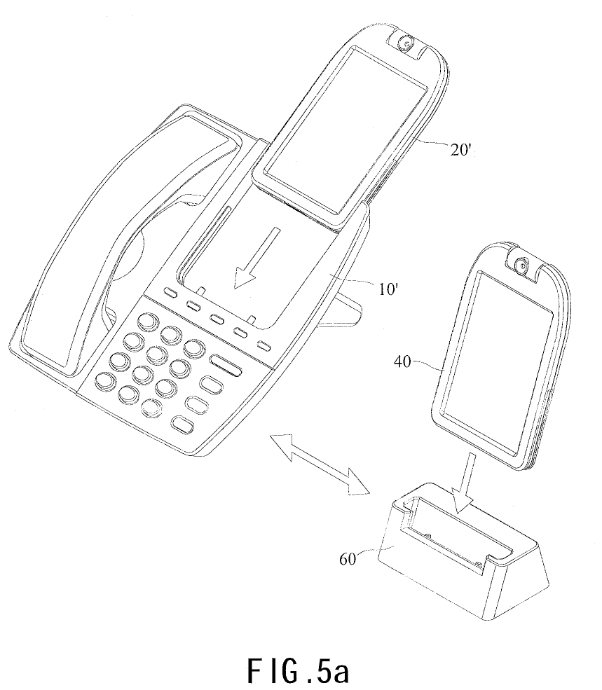

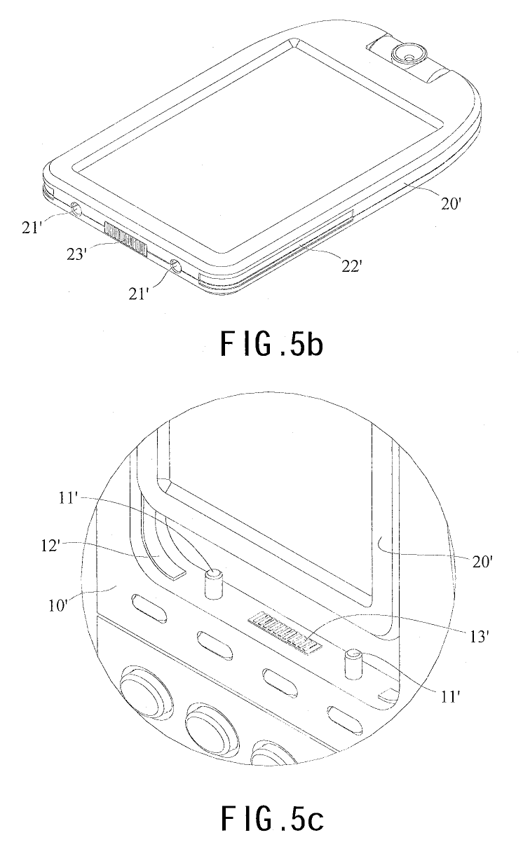

The specific embodiments of the method for assembling the phone set 10 with the second screen device 40 have been illustrated above in detail, and another embodiment of the video phone device of the present invention will now be described below with reference to FIGS. 5a to 5c, they are schematic views of the video phone device according to another embodiment of the present invention. In this embodiment, the first screen device 20′ of the phone set 10′ is removable, that is, when the dimension and structure of the first screen device 20′ is the same as that of the second screen device 40, both of them can be alternated with each other. The first screen device 20′ with the above function will be illustrated below in detail with reference to FIGS. 5b and 5c.

As shown in FIG. 5b, the first screen device 20′ has a guide slot 22′, a plurality of guide holes 21′, and a plurality of pins 23′ electrically connected to the phone set 10′, and the structures of the guide slot 22′, the guide holes 21′, and the pins 23′ are similar to that of the second screen device 40 shown in FIG. 2a, which thus will not be described herein repeatedly. In additional, for being matched with the first screen device 20′, as shown in FIG. 5c, the phone set 10′ is correspondingly disposed with a guide rail 12′, a plurality of pillars 11′, and pins 13′, whose structures and dimensions are similar to that of the guide rail 62, the plurality of pillars 61, and pins 63 of the base 60 respectively, such that the first screen device 20′ is combined and positioned on the phone set 10′. Additionally, the pillars 11′ and the guide holes 21′ may be fixed and matched with each other under a magnetic force for enhancing the fixing effect. Therefore, an alternation between the first screen device 20′ and the second screen device 40 may be achieved through the above structure, and when a user intends to move the first screen device 20′ to other positions, the screen is drawn out, thereby the object of using the second screen device can be achieved. Furthermore, through placing the base with the charging and signal transmission functions at other positions before hand, the maximum service efficiency of one screen device and the expected object of mobility can be achieved.

The video phone device of the present invention has advantages of enlarging the screen of the current video phone, thereby increasing the number of users and using range of the picture phone, and providing a better mobility than that of prior art.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A video phone device, comprising:
a phone set for establishing video and audio communications with a communication partner over a network;
a first screen device installed on the phone set for displaying a video image from the communication partner;
a first video camera device installed on the first screen device for capturing an image information; and
a second screen device connected to the phone set in a wired or wireless communication way for displaying the video image of the communication partner.

2. The video phone device as claimed in claim 1, wherein as for the wired communication way of the second screen device, the transmission medium for the video image is selected from a group consisting of a network cable, a USB transmission line, a coaxial cable, and an audio-video transmission line.

3. The video phone device as claimed in claim 1, wherein as for the wireless communication way, the transmission medium for the image signal is selected from a group consisting of WiMax, WiFi, and blue-tooth technology.

4. The video phone device as claimed in claim 1, wherein the first screen device is a removable screen device.

5. The video phone device as claimed in claim 4, wherein the phone set comprises:
a guide rail; and
a plurality of pillars;
wherein the first screen device has a guide slot and a plurality of guide holes, the number and dimension of the guide slot and each of the guide holes are corresponding to that of the guide rail and each of the pillars, and the guide rail is matched with the guide slot, and each of the pillars is also matched with each of the guide holes, such that the first screen device is combined and positioned on the phone set.

6. The video phone device as claimed in claim 5, wherein the matching between each of the pillars and each of the guide holes is further fixed with a magnetic force.

7. The video phone device as claimed in claim 5, wherein the first screen device is alternated with the second screen device.

8. The video phone device as claimed in claim 1, wherein a second video camera device is further installed on the second screen device and used for capturing image information and then transmitting the image information to the phone set in a wired or wireless communication way.

9. The video phone device as claimed in claim 1, wherein a stand is installed within the second screen device, and connected to the second screen device via a spindle mechanism to support the second screen device.

10. The video phone device as claimed in claim 1, wherein the second screen device has a base for fixing the second screen device.

11. The video phone device as claimed in claim 10, wherein the base is a platform-shaped base or a wall-hung base.
